(19) United States
(12) Patent Application Publication
(10) Pub. No.: US 2015/0004551 A1
(43) Pub. Date: Jan. 1, 2015

(54) CANDLE HOLDER

(71) Applicant: Grace Management Group, LLC, Spartanburg, SC (US)

(72) Inventor: Heidi S. Ruehl, Spartanburg, SC (US)

(73) Assignee: Grace Management Group, LLC, Spartanburg, SC (US)

(21) Appl. No.: 14/314,135

(22) Filed: Jun. 25, 2014

Related U.S. Application Data
(60) Provisional application No. 61/840,006, filed on Jun. 27, 2013.

(51) Int. Cl. F21V 35/00; B21D 51/16

(52) U.S. Cl. CPC F21V 35/00; B21D 51/16
USPC 431/289; 72/379.4

(57) ABSTRACT

A candle holder includes a shell that defines a chamber. A first end portion of the shell and a second end portion of the shell project in a circumferential direction and are connected to each other at a seam of the shell. The candle holder also includes a liner positioned within the chamber of the shell. The liner defines a seamless well for receiving a candle. The candle holder seamed shell is capable of being manipulated into a variety of shapes or decorated while the seamless well liner limits or hinders spilling of liquid fuel during burning of an associated candle.

### PRIORITY CLAIM

This application claims the benefit of previously filed U.S. Provisional Patent Application entitled “CANDLE HOLDER,” assigned U.S. Ser. No. 61/840,006, filed Jun. 27, 2013, and which is incorporated herein by reference for all purposes.

### FIELD OF THE SUBJECT MATTER

The presently disclosed subject matter relates generally to candle holders and containers.

### BACKGROUND OF THE SUBJECT MATTER

Candles generally include a solid fuel, such as wax, and a wick positioned within the solid fuel. After lighting the wick, the solid fuel melts and travels up the wick via capillary action. Within the wick, the liquid fuel vaporizes and burns to form a flame. In certain candles, the solid fuel is positioned within a holder or container. The candle holder can support the candle and contain the liquid fuel when the candle is burning. The candle holder can also be decorative and provide a pleasant cosmetic appearance to candle users.

Various candle holders are available for supporting candles. However, such candles holders generally suffer from various problems and drawbacks. As an example, U.S. Patent Application No. 2009/0233249 provides a candle body 1 positioned within a container 7, such as a jar. The container 7 has a simple cylindrical design that certain candle users could find aesthetically unappealing. In addition, the container 7 is easily heated to a temperature that can limit handling of the container 7 as a wick 4 of the candle body 1 burns. Thus, the candle within the container 7 can be difficult to use.

As another example, certain candle holders are constructed with a metal sheet having seamed joints. As a candle within such candle holders burns, liquid fuel can flow out of the candle holder through the seamed joints and onto underlying furniture. The liquid fuel can damage, e.g., stain or burn, the underlying furniture and can otherwise be difficult to clean or remove.

As a further example, certain candle holders are constructed with a metal sheet that is drawn or pressed into shape. The final shape of such candle holders can be limited to a generally cylindrical shape due to material limitations of the metal sheet. In addition, decorating such candle holders can be difficult due to the plastic deformation experienced by the metal sheet during manufacturing.

Accordingly, a candle holder with features for limiting fuel leaks of associated candles while also permitting the candle holder to be constructed in a variety of shapes and/or with a variety of decorations applied thereon would be useful.

### BRIEF DESCRIPTION OF THE SUBJECT MATTER

The presently disclosed subject matter recognizes and variously addresses the foregoing issues, and others concerning certain aspects of candle holders. Thus, broadly speaking, an object of certain embodiments of the presently disclosed subject matter is to provide improved designs for candle holders.

More particularly, the presently disclosed subject matter provides a candle holder with features for limiting fuel leaks of associated candles while permitting the candle holder to be constructed in a variety of shapes and/or with a variety of decorations applied thereon.

Additional aspects and advantages of the presently disclosed subject matter will be set forth in part in the following description, or may be apparent from the description, or may be learned through practice of the presently disclosed subject matter.

In a first exemplary embodiment of the presently disclosed subject matter, a candle holder is provided. The candle holder includes a shell that extends between a first end portion and a second end portion along a circumferential direction of the candle holder. The first and second end portions of the shell are positioned adjacent each other and are connected to each other at a seam of the shell. The candle holder also includes a liner positioned within a chamber of the shell. The liner defines a seamless well for receipt of a candle.

The construction of the shell can permit the shell to have a variety of shapes, e.g., in a plane that is perpendicular to an axial direction of the candle holder. For example, the shell may have a circular, oval, triangular, rectangular, trefoil, quatrefoil, or any other suitable shape in a plane that is perpendicular to the axial direction. As an example, a piece of material, such as a metal, may be bent or otherwise plastically deformed on a mold to provide the shell with any suitable shape in a plane that is perpendicular to the axial direction. Prior to plastically deforming the piece of material, decoration, such as a design, a pattern, lettering, numbering, or a logo, can be applied or printed onto the piece of material, and/or otherwise embossed into such material. Thus, the construction of the shell can also permit the shell to be easily decorated.

The seamless well of the liner can limit or reduce fuel leaks during burning of an associated candle positioned within the seamless well. In particular, liquid fuel of the associated candle is contained within the seamless well of the liner, and the lack of seams can limit or hinder liquid fuel from undesirably flowing out of the seamless well of the liner. In such a manner, the candle holder can limit the flow of liquid fuel out of the candle holder, e.g., onto underlying furniture.

Thus, the candle holder includes a shell that can have a variety of shapes and can be easily decorated and which also includes a liner with a seamless well for limiting or hindering spilling of liquid fuel during burning of an associated candle.

In an additional presently disclosed exemplary embodiment, the seamless well of the liner is spaced apart from the shell along the radial direction. In another presently disclosed exemplary embodiment, the candle holder includes a bottom wall. The bottom wall is mounted to the shell at a bottom portion of the shell. The seamless well of the liner may be spaced apart from the bottom wall of the candle holder along the axial direction.

By spacing the seamless well of the liner from the shell and/or the bottom wall, a candle positioned within the seamless well can also be spaced apart from the shell and/or the bottom wall. Such spacing can assist with limiting heat transfer from between the candle and the shell and/or the bottom wall. In particular, such spacing can limit or reduce conductive heat transfer between the seamless well and the shell and/or the bottom wall. In such a manner, the shell and/or the bottom wall can remain relatively cool compared to the candle while the candle is burning. Thus, a user of the candle holder can more easily carry candle holder, e.g., by grasping the shell, while the candle burns within the seamless well of the liner. Also, such spacing can hinder or limit heat transfer between the seamless well and underlying furniture.

In yet another presently disclosed exemplary embodiment, the seamless well of the liner has a circular cross-section in a plane that is perpendicular to the axial direction. The seamless well of the liner may extend between a top portion and a bottom portion along the axial direction and may have a substantially uniform circular shape along the axial direction between the top and bottom portions of the seamless well.

By providing the seamless well of the liner with a substantially uniform circular shape along the axial direction, a candle positioned within the seamless well of the liner can burn cleanly. For example, such a shape can limit or prevent over-wicking of the candle and the associated soot and heat generated by such over-wicking.

In another presently disclosed exemplary embodiment, the candle holder includes a lid. The shell extends between a top portion and a bottom portion along the axial direction and also defines an opening at the top portion of the shell. The lid is selectively mounted to the shell at the opening of the shell in order to permit selective access to the seamless well of the liner.

In yet a further exemplary embodiment of the presently disclosed subject matter, a method for making a candle holder is provided. The candle holder defines an axial direction, a radial direction, and a circumferential direction. The method includes providing a first sheet of material and a second sheet of material. The first sheet of material has a first end portion and a second end portion spaced apart from each other. The method also includes bending the first sheet of material such that the first sheet of material extends along the circumferential direction between the first and second end portions and the first and second end portions of the first sheet of material are positioned adjacent each other, seaming the first and second end portions of the first sheet of material together in order to form a shell with the first sheet of material with the shell defining a chamber, drawing the second sheet of material in order to form a liner with the liner defining a seamless well for receipt of a candle, positioning the liner within the chamber of the shell, and mounting the liner to the shell.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 provides a perspective view of a candle holder according to an exemplary embodiment of the presently disclosed subject matter with a lid of the exemplary candle holder positioned on a base of the exemplary candle holder;

FIG. 2 provides a perspective view of the exemplary candle holder of FIG. 1 with the lid of the exemplary candle holder removed from the base of the exemplary candle holder;

FIG. 3 provides an exploded view of the base of the exemplary candle holder of FIG. 1;

FIG. 4 provides a perspective view of a candle holder according to another exemplary embodiment of the presently disclosed subject matter with a lid of the exemplary candle holder positioned on a base of the exemplary candle holder;

FIG. 5 provides a perspective view of the exemplary candle holder of FIG. 4 with the lid of the exemplary candle holder removed from the base of the exemplary candle holder;

FIG. 6 provides an exploded view of the base of the exemplary candle holder of FIG. 4;

FIG. 7 provides a perspective view of a candle holder according to an additional exemplary embodiment of the presently disclosed subject matter with a lid of the exemplary candle holder positioned on a base of the exemplary candle holder;

FIG. 8 provides a perspective view of the exemplary candle holder of FIG. 7 with the lid of the exemplary candle holder removed from the base of the exemplary candle holder; and

FIG. 9 provides an exploded view of the base of the exemplary candle holder of FIG. 7.

Repeat use of reference characters throughout the present specification and appended drawings is intended to represent same or analogous features, elements, or steps of the presently disclosed subject matter.

### DETAILED DESCRIPTION OF THE SUBJECT MATTER

Reference is made herein in detail to embodiments of the presently disclosed subject matter, one or more examples of which are illustrated in the drawings. Each example is provided by way of explanation of the presently disclosed subject matter, not limitation of the presently disclosed subject matter. In fact, it will be apparent to those skilled in the art that various modifications and variations can be made in the presently disclosed subject matter without departing from the scope or spirit of the presently disclosed subject matter. For instance, features illustrated or described as part of one embodiment can be used with another embodiment to yield a still further embodiment. Thus, it is intended that the presently disclosed subject matter covers such modifications and variations as come within the scope of the appended claims and their equivalents.

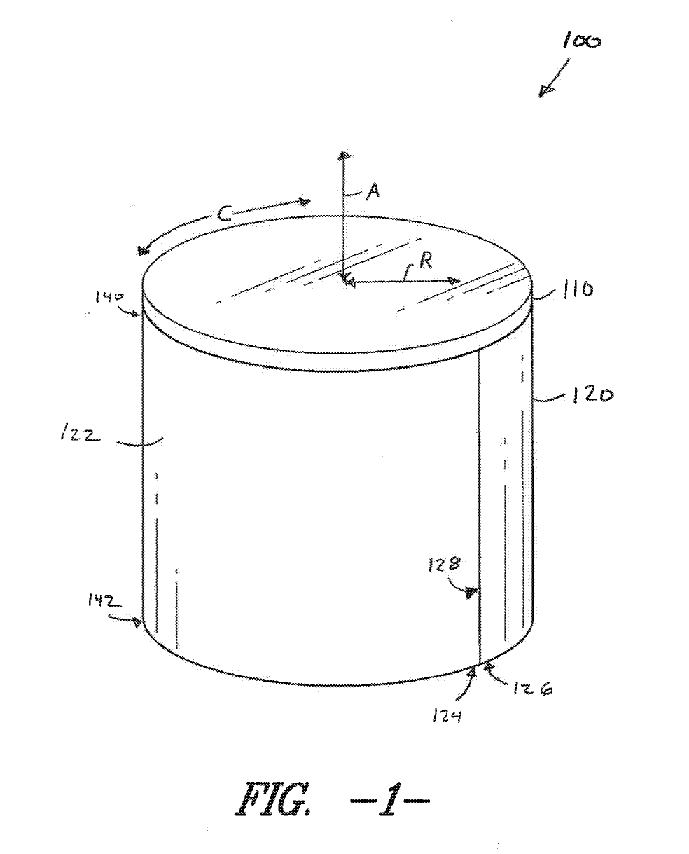

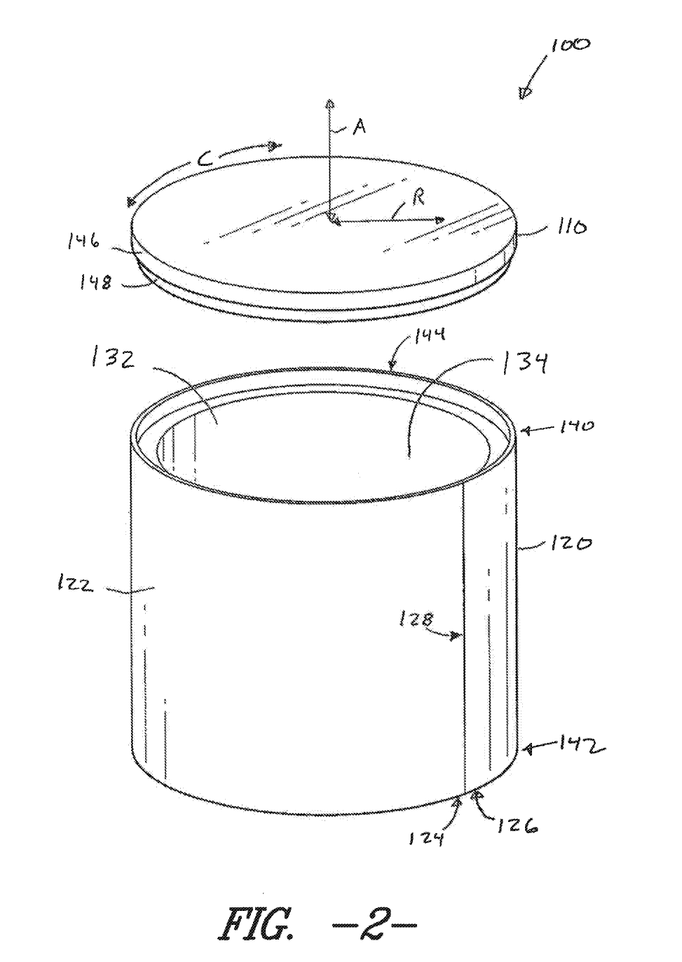

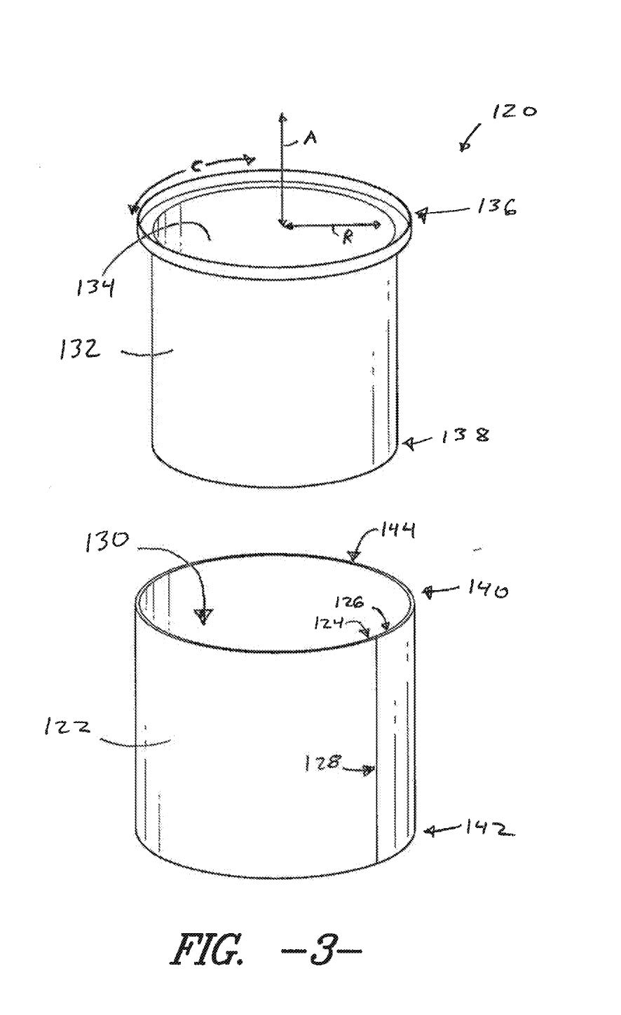

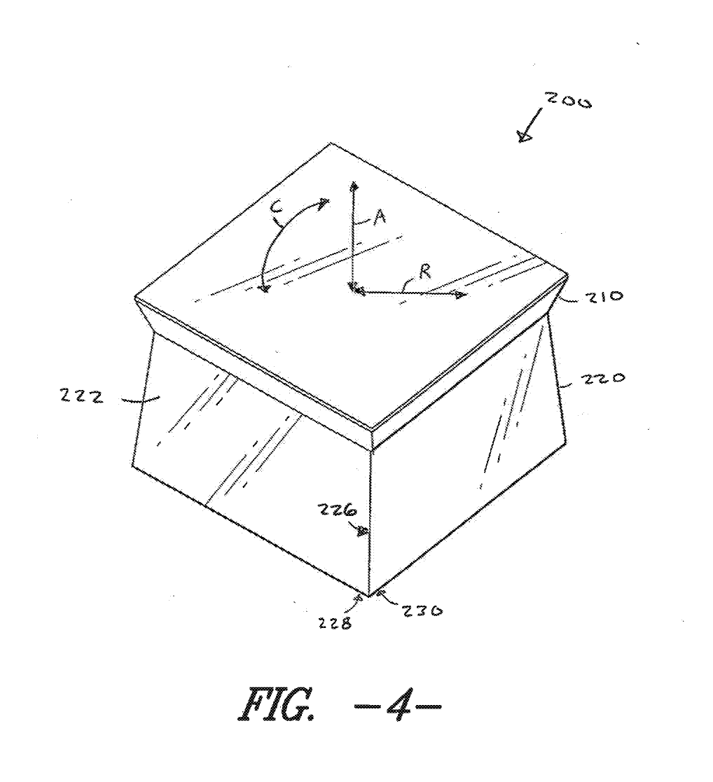

FIG. 1 provides a perspective view of a candle holder generally 100 according to an exemplary embodiment of the presently disclosed subject matter with a lid 110 of candle holder 100 positioned on a base 120 of candle holder 100. FIG. 2 provides a perspective view of candle holder 100 with lid 110 of candle holder 100 removed from base 120 of candle holder 100. FIG. 3 provides an exploded view of base 120 of candle holder 100. As may be seen in FIGS. 1, 2, and 3, candle holder 100 defines an axial direction A, a radial direction R, and a circumferential direction C.

Base 120 of candle holder 100 includes a shell 122. Shell 122 extends along the circumferential direction C between a first end portion 124 and a second end portion 126. First and second end portions 124 and 126 of shell 122 are preferably positioned proximate or adjacent each other. In addition, first and second end portions 124 and 126 of shell 122 are preferably connected or coupled to each other, e.g., at a seam 128 of shell 122. When the respective end portions are so arranged and connected, shell 122 also defines a chamber 130 (FIG. 3) therein.

Shell 122 of base 120 can define any suitable outline or shape, e.g., in a plane that is perpendicular to the axial direction A. For example, in the exemplary embodiment shown in FIGS. 1, 2, and 3, shell 122 of base 120 defines a circular outline or shape in a plane that is perpendicular to the axial direction A. As discussed in greater detail below, as an aspect of presently disclosed subject matter, shell 122 of base 120 can advantageously be provided with any other suitable outline or shape in alternative exemplary embodiments.

As may be seen in FIGS. 2 and 3, base 120 of candle holder 100 also preferably includes a liner 132. Liner 132 is positioned within chamber 130 of shell 122. Liner 132 defines a seamless well 134. Seamless well 134 of liner 132 is configured, e.g., sized and shaped, for receipt of a candle, for example, such as a tea candle or a votive candle. Liner 132 (and the presently disclosed subject matter generally) may conform to various sizes, as desired or needed to best work with particular candles. Liner 132 is mounted or secured to shell 122 as discussed in greater detail below.

In addition, seamless well 134 of liner 132 can have any suitable shape. For example, seamless well 134 of liner 132 may have a circular cross-section, e.g., in a plane that is perpendicular to the axial direction A. In particular, as shown in FIG. 3, seamless well 134 of liner 132 extends between a top portion 136 and a bottom portion 138, e.g., along the axial direction A. Seamless well 134 of liner 132 may have a substantially uniform circular shape (e.g., a constant diameter) along the axial direction A between top and bottom portions 136 and 138 of seamless well 134. In alternative exemplary embodiments, seamless well 134 of liner 132 may have an oval or rectangular cross-section, e.g., in a plane that is perpendicular to the axial direction A, or may have other shapes, either regular or non-regular or mixtures thereof.

As shown in FIGS. 1 and 2, lid 110 of candle holder 100 may be selectively positioned on or mounted to base 120 of candle holder 100. In such a manner, lid 110 of candle holder 100 may permit selective access to a candle (not shown) positioned within seamless well 134 of liner 132. In particular, a user is hindered or obstructed from accessing a candle within seamless well 134 of liner 132 when lid 110 is positioned on or mounted to base 120 of candle holder 100 as shown in FIG. 1. Conversely, a user may access an associated candle within seamless well 134 of liner 132 when lid 110 is removed from base 120 of candle holder 100 as shown in FIG. 2.

Shell 122 of base 120 extends between an upper portion 140 and a lower portion 142, e.g., along the axial direction A. Shell 122 also defines an opening 144. Opening 144 of shell 122 is positioned proximate upper portion 140 of shell 122. A user can selectively position or mount lid 110 at opening 144 of shell 122 and thereby regulate access to seamless well 134 of liner 132 and associated candles via opening 144.

As may be seen in FIG. 2, lid 110 may include a cap 146 and a plug 148. Cap 146 and plug 148 are mounted to each other. Plug 148 may be received within chamber 130 of shell 122, e.g., such that plug 148 contacts shell 122. Friction between plug 148 of lid 110 and shell 122 can assist with mounting or securing lid 110 to base 120. In other words, an interference fit may be formed. Conversely, cap 146 of lid 110 remains positioned outside of chamber 130 of shell 122, e.g., when lid 110 is positioned on or mounted to base 120. A user can grasp cap 146 of lid 110 to assist the user with either removing lid 110 from base 120 or placing lid 110 on base 120.

The presently disclosed subject matter also encompasses various exemplary method embodiments of making a candle holder, such as candle holder 100. Such exemplary method embodiments of making a candle holder can include providing a first sheet of material and a second sheet of material. As discussed in greater detail below, shell 122 of base 120 is constructed with or from the first sheet of material. Conversely, liner 132 of base 120 is constructed with or from the second sheet of material.

The first and second sheets of material can be any suitable material. For example, the first and second sheets of material may be a metal, such as steel, aluminum, tin, copper, and/or alloys thereof. In certain exemplary embodiments, the first and second sheets of material are constructed with the same materials. However, in alternative exemplary embodiments, the first and second sheets of material may be constructed with respective different materials. Thus, shell 122 of base 120 and liner 132 of base 120 may be constructed with or from either the same or different materials, depending upon the materials selected for the first and second sheets of material.

The first sheet of material extends between a first end portion (e.g., first end portion 124 of shell 122) and a second end portion (e.g., second end portion 126 of shell 122). To form shell 122 of base 120, the first sheet of material may be plastically deformed such that the first sheet of material extends along the circumferential direction C between the first and second end portions. In particular, the first and second end portions of the first sheet of material are positioned adjacent each other when the first sheet of material is plastically deformed. As an example, the first sheet of material may be bent on a roll bender or a mold in order to plastically deform the first sheet of material. After plastically deforming the first sheet of material, the first and second end portions of the first sheet of material are secured together or attached to each other at seam 128 in order to form shell 122 with chamber 130 therein.

To form liner 132 of base 120, the second sheet of material is plastically deformed such that liner 132 defines seamless well 134. As an example, the second sheet of material may be pressed or deep drawn with a die and punch in order to plastically deform the second sheet of material and form seamless well 134, After forming shell 122 and liner 132, liner 132 is positioned within chamber 130 of shell 122 and mounted or attached to shell 122. As an example, shell 122 may be crimped or rolled onto liner 132, e.g., at upper portion 140 of shell 122, in order to mount liner 132 to shell 122. Utilizing the above subject methodology, flat or planar sheets of material can be plastically deformed in order to construct base 120 of candle holder 100.

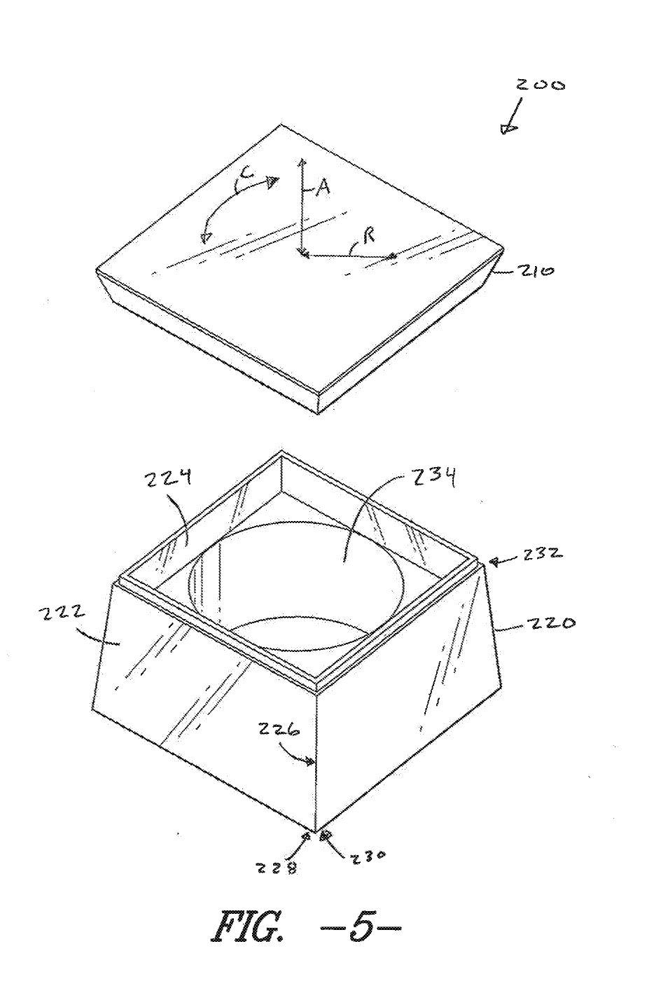

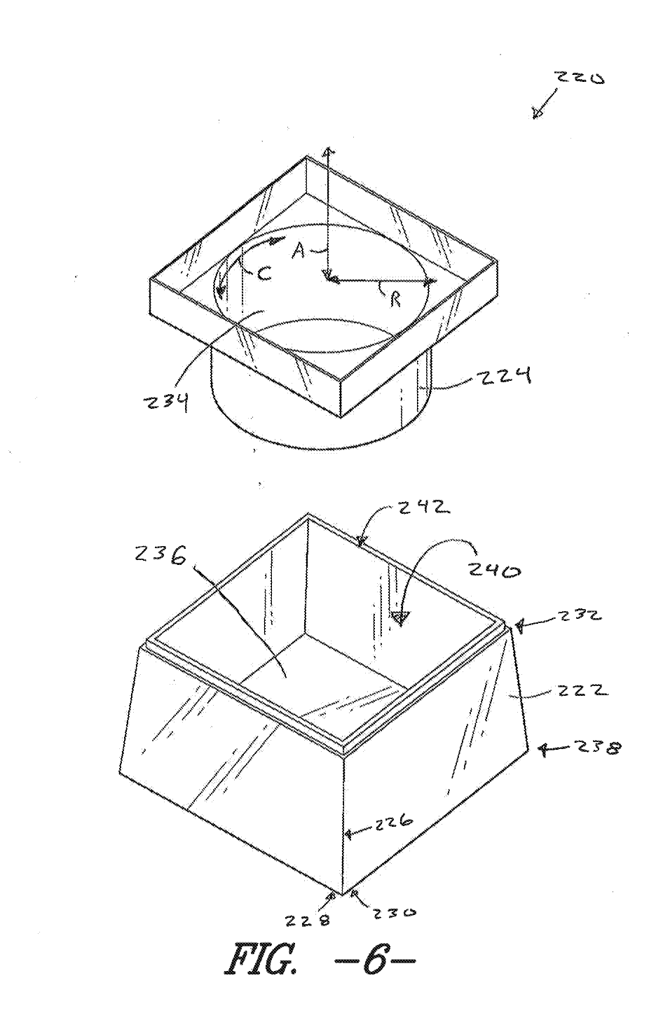

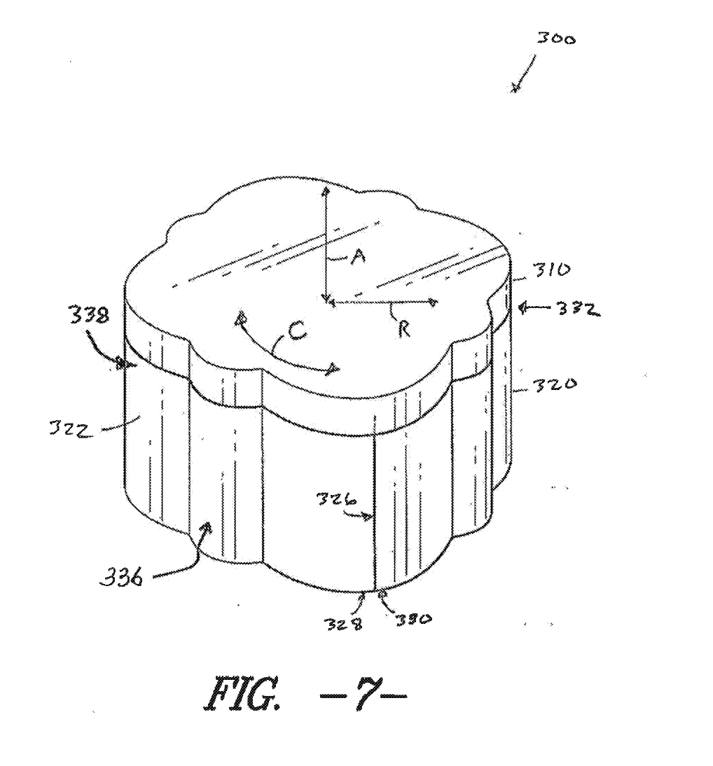

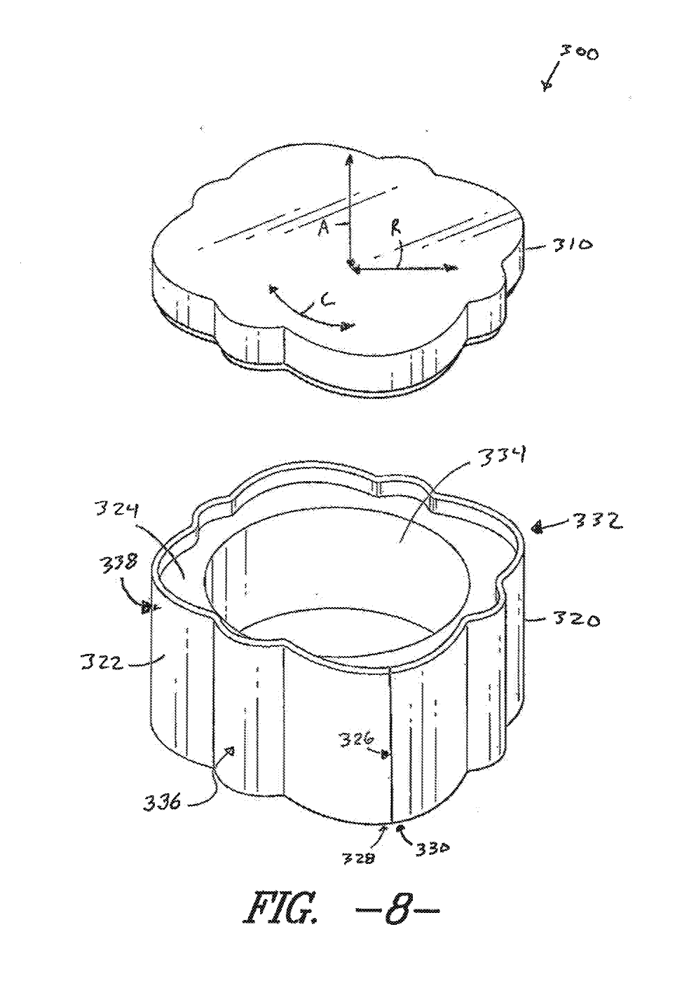

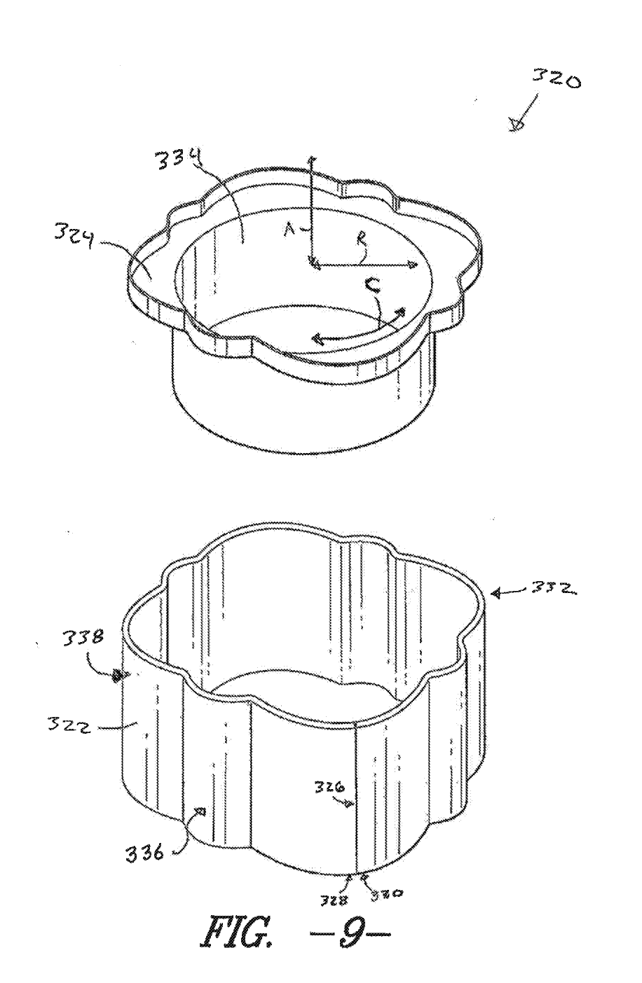

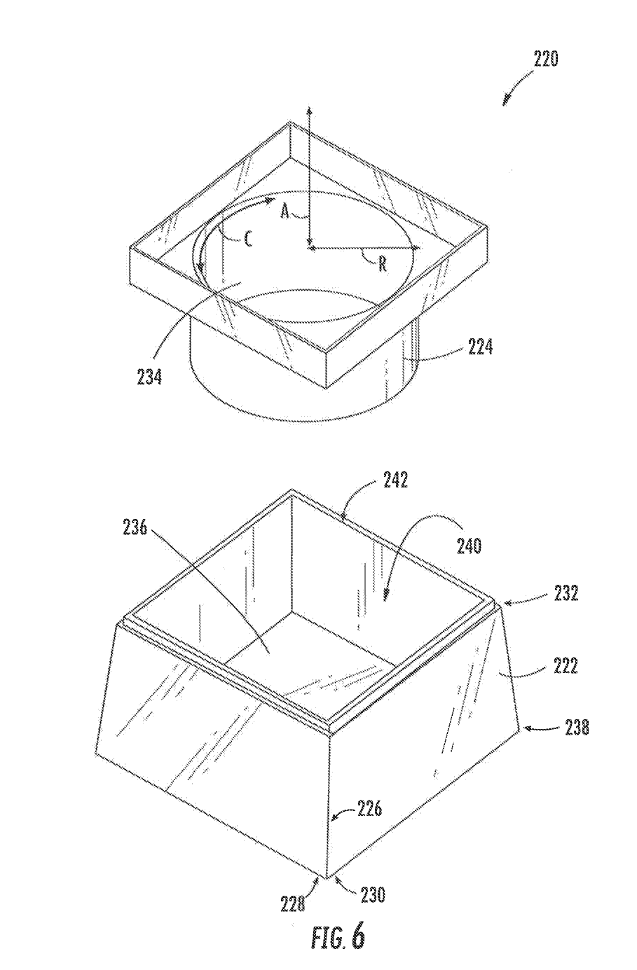

FIG. 4 provides a perspective view of a candle holder generally 200 according to another exemplary embodiment of the presently disclosed subject matter with a lid 210 of candle holder 200 positioned on a base 220 of candle holder 200. FIG. 5 provides a perspective view of candle holder 200 with lid 210 of candle holder 200 removed from base 220 of candle holder 200. FIG. 6 provides an exploded view of base 220 of candle holder 200.

Candle holder 200 is substantially similar to candle holder 100 (FIG. 1) and may be constructed in a similar manner with similar components. As an example and as may be seen in FIGS. 5 and 6, base 220 of candle holder 200 includes an outer shell 222 and an inner liner 224. Outer shell 222 includes a seam 226 where a first end portion 228 of outer shell 222 and a second end portion 230 of outer shell 222 are joined or connected to each other. Also, inner liner 224 is positioned within outer shell 222 and is mounted to outer shell 222, e.g., at a top portion 232 of outer shell 222. Inner liner 224 defines a seamless well 234 for receipt of at least one candle.

As may be seen in FIGS. 4, 5, and 6, outer shell 222 of base 220 has a different exemplary shape than shell 122 of base 120 (FIG. 1), e.g., in a plane that is perpendicular to the axial direction A. In particular, outer shell 222 of base 220 has a square shape in a plane that is perpendicular to the axial direction A. Thus, as discussed above with respect to candle holder 100, a first piece of material may be bent to provide outer shell 222 of base 220 with the square shape shown in FIGS. 4, 5, and 6, and first and second end portions 228 and 230 of outer shell 222 may be secured or seamed together at seam 226 to form outer shell 222.

As shown in FIG. 6, candle holder 200 also preferably includes a bottom wall 236. Bottom wall 236 is mounted to outer shell 222, e.g., at a bottom portion 238 of outer shell 222. As an example, outer shell 222 may be crimped or rolled onto bottom wall 236 at bottom portion 238 of outer shell 222 in order to mount bottom wall 236 to outer shell 222. Bottom wall 236 can hinder access to a chamber 240 of outer shell 222. In particular, bottom wall 236 can hinder access to a chamber 240 of outer shell 222 at bottom portion 238 of outer shell 222, e.g., such that chamber 240 of outer shell 222 is only accessible through an opening 242 of outer shell 222 at top portion 232 of outer shell 222.

Bottom wall 236 and outer shell 222 are spaced apart from seamless well 234 of inner liner 224 when inner liner 224 is mounted to outer shell 222 as shown in FIG. 5. In particular, bottom wall 236 is spaced apart from seamless well 234 of inner liner 224 along the axial direction A. Similarly, outer shell 222 is spaced apart from seamless well 234 of inner liner 224 along the radial direction R. Thus, chamber 240 of outer shell 222 separates bottom wall 236 and outer shell 222 from seamless well 234 of inner liner 224.

FIG. 7 provides a perspective view of a candle holder generally 300 according to an additional exemplary embodiment of the presently disclosed subject matter with a lid 310 of candle holder 300 positioned on a base 320 of candle holder 300. FIG. 8 provides a perspective view of candle holder 300 with lid 310 of candle holder 300 removed from base 320 of candle holder 300. FIG. 9 provides an exploded view of base 320 of candle holder 300.

Candle holder 300 is substantially similar to candle holder 100 (FIG. 1) and candle holder 200 (FIG. 3). In particular, candle holder 300 may be constructed in a similar manner and with similar components as candle holder 100 and candle holder 200. As an example and as shown in FIGS. 8 and 9, base 320 of candle holder 300 includes a shell 322 and a liner 324. Shell 322 includes a seam 326 where a first end portion 328 of shell 322 and a second end portion 330 of shell 322 are joined or connected to each other. Also, liner 324 is positioned within shell 322 and is mounted to shell 322, e.g., at a top portion 332 of shell 322. Liner 324 defines a seamless well 334 for receipt of at least one candle.

As may be seen in FIGS. 7, 8, and 9, shell 322 of base 320 has a different exemplary shape than shell 122 of base 120 (FIG. 1) and outer shell 220 of base 220 (FIG. 3), e.g., in a plane that is perpendicular to the axial direction A. In particular, shell 322 of base 320 has a, e.g., barbed, quatrefoil shape in a plane that is perpendicular to the axial direction A. Thus, as discussed above with respect to candle holder 100, a first piece of material may be bent to provide shell 322 of base 320 with the quatrefoil shape shown in FIGS. 7, 8, and 9, and first and second end portions 328 and 330 of shell 322 may be secured or seamed together at seam 326 to form shell 322.

Ink or pigment generally 336 may be applied or printed on an outer surface 338 of shell 322. In the exemplary embodiment shown in FIGS. 7, 8, and 9, an exemplary position of pigment 336 is indicated. As will be understood by those of ordinary skill in the art without limitation, such applied material 336 may define any variety of repeating geometric patterns of quatrefoils, stars, squares, and other geometric or non-geometric shapes printed onto outer surface 338 of shell 322. Pigment 336 may be applied or printed onto a surface of the first sheet of material prior to bending the first sheet of material to form shell 322 in the manner discussed above.

It should be understood that candle holder 100 (FIG. 1), candle holder 200 (FIG. 4), and candle holder 300 (FIG. 7) are provided by way of example only and are not intended to limit the presently disclosed subject matter in any aspect. In particular, the shapes of shell 122, outer shell 222, and shell 322 are provided by way of example only and may have any other suitable shape in alternative exemplary embodiments. For example, shell 122 of base 120 may have an oval shape, a star shape, a trefoil shape, a triangular shape, or a pentagonal shape in alternative exemplary embodiments. Similarly, any suitable graphic may be defined by pigment applied to an outer surface 150 of shell 122 in alternative exemplary embodiments. For example, a logo, at least one letter or series of letters, a word or series of words, a number or series of numbers, a geometric shape, and/or a picture may be printed on outer surface 150 of shell 122 in alternative exemplary embodiments.

The present written description uses examples to disclose the presently disclosed subject matter, including the best mode, and also to enable any person skilled in the art to practice the presently disclosed subject matter, including making and using any devices or systems and performing any incorporated, involved, or corresponding methods. While the presently disclosed subject matter has been described in detail with respect to specific embodiments thereof, it will be appreciated that those skilled in the art, upon attaining an understanding of the foregoing, may readily adapt the present technology for alterations or additions to, variations of, and/or equivalents to such embodiments. Accordingly, the scope of the present disclosure is by way of example rather than by way of limitation, and the subject disclosure does not preclude inclusion of such modifications, variations, and/or additions to the presently disclosed subject matter as would be readily apparent to one of ordinary skill in the art.

What is claimed is:

1. A candle holder defining an axial direction, a radial direction, and a circumferential direction, the candle holder comprising:
a shell extending between a first end portion and a second end portion along the circumferential direction, the first and second end portions of said shell positioned adjacent each other and connected to each other at a seam of said shell, said shell extending between a top portion and a bottom portion along the axial direction, said shell defining a chamber; and
a seamless liner positioned within the chamber of said shell, and defining a seamless well for receipt of a candle.

2. The candle holder of claim 1, wherein said liner is mounted to said shell such that the seamless well of said liner is spaced apart from said shell along the radial direction.

3. The candle holder of claim 1, said shell defines a shape in a plane that is perpendicular to the axial direction, the shape comprising at least one of a circle, a square, a star, and a quatrefoil.

4. The candle holder of claim 1, further comprising a graphic positioned on an outer surface of said shell.

5. The candle holder of claim 4, wherein the graphic comprises at least one of a letter, a number, a geometric shape, and a logo.

6. The candle holder of claim 1, further comprising a bottom wall mounted to said shell at the bottom portion of said shell.

7. The candle holder of claim 6, wherein the seamless well of said liner is spaced apart from the bottom wall along the axial direction.

8. The candle holder of claim 1, wherein the seamless well of said liner has a circular cross-section in a plane that is perpendicular to the axial direction.

9. The candle holder of claim 8, wherein the seamless well of said liner extends between a top portion and a bottom portion along the axial direction, and has a substantially uniform circular shape along the axial direction between the top and bottom portions of the seamless well.

10. The candle holder of claim 1, further comprising a lid; and
wherein said shell defines an opening positioned proximate the top portion of said shell; and
said lid is selectively mounted to said shell at the opening of said shell in order to permit selective access to the seamless well of said liner,

11. A method for making a candle holder, the candle holder defining an axial direction, a radial direction, and a circumferential direction, the method comprising:
providing a first sheet of material and a second sheet of material, the first sheet of material having a first end portion and a second end portion spaced apart from each other;
bending the first sheet of material such that the first sheet of material extends along the circumferential direction between the first and second end portions and the first and second end portions of the first sheet of material are positioned adjacent each other;
seaming the first and second end portions of the first sheet of material together in order to form a shell with the first sheet of material, said shell defining a chamber;
drawing the second sheet of material in order to form a liner, said liner defining a seamless well for receipt of a candle;
positioning said liner within the chamber of said shell; and
mounting said liner to said shell.

12. The method of claim 11, further comprising applying a graphic to a surface of the first sheet of material prior to said step of bending.

13. The method of claim 12, wherein the graphic comprises at least one of a letter, a number, a geometric shape, and a logo.

14. The method of claim 11, wherein the first sheet of material defines a shape in a plane that is perpendicular to the axial direction after said step of bending, the shape comprising at least one of a circle, a square, a star, and a quatrefoil.

15. The method of claim 11, further comprising:
providing a bottom wall; and
securing the bottom wall to said shell at a bottom portion of said shell.

16. The method of claim 15, wherein the seamless well of said liner is spaced apart from the bottom wall along the axial direction.

17. The method of claim 11, wherein the seamless well of said liner has a circular cross-section in a plane that is perpendicular to the axial direction.

18. The method of claim 17, wherein the seamless well of said liner extends between a top portion and a bottom portion along the axial direction, the seamless well of said liner having a substantially uniform circular shape along the axial direction between the top and bottom portions of the seamless well.

19. The method of claim 11, wherein said step of mounting comprises at least one of crimping and rolling said shell onto said liner at a top portion of said shell.

20. The method of claim 11, wherein the seamless well of said liner is spaced apart from said shell along the radial direction.
